(19) United States
(12) Patent Application Publication
(10) Pub. No.: US 2003/0059146 A1
(43) Pub. Date: Mar. 27, 2003

(54) Finned electrode structure for optical modulators

(76) Inventor: Dariush Mirshekar-Syahkal, Colchester (GB)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/109,769

(22) Filed: Mar. 29, 2002

Related U.S. Application Data
(60) Provisional application No. 60/323,856, filed on Sep. 21, 2001.

(51) Int. Cl. G02F 1/035; G02F 1/03; G02F 1/07

(52) U.S. Cl. 385/2

(57) ABSTRACT

An optical modulator electrode structure includes a drive signal electrode having a coplanar section that is coplanar with at least one ground electrode. The drive signal electrode also includes a fin section and a wall section connecting the fin section to the coplanar section. The fin section overlaps at least a portion of a ground electrode and dielectric material is located between the fin section and the underlying ground electrode. The electrode structure transmits electromagnetic energy in two modes: a coplanar waveguide mode and a microstrip mode. The electrodes may be formed on an optical waveguide substrate, such as lithium niobate, or on a dielectric layer overlying the optical waveguide substrate. In a typical optical modulator application, the electrode structure should (or is believed to) exhibit less conductor losses and facilitates better velocity matching.

### CROSS REFERENCE TO RELATED APPLICATION

This application claims priority of U.S. provisional patent application serial No. 60/323,856, titled FIN-TYPE ELECTRODE STRUCTURE FOR TRAVELING-WAVE OPTICAL MODULATORS, the content of which is hereby incorporated by reference.

### FIELD OF THE INVENTION

The present invention relates generally to optical modulators. More particularly, the present invention relates to the design of electrodes utilized in optical modulators.

### BACKGROUND OF THE INVENTION

Traveling-wave optical modulators are utilized in a number of applications, such as broadband, high-speed, fiber-optic communications systems. For example, Mach-Zehnder modulators are used in many practical communications applications. Mach-Zehnder optical modulators are well known to those skilled in the art and, therefore, are not described in detail herein. Briefly, a typical Mach-Zehnder optical modulator receives a data signal from a driver amplifier component, along with an unmodulated continuous wave (CW) optical input. The optical modulator modulates the optical signal in response to the electrical data signal. The optical input is carried by an optical waveguide formed within a substrate, and the electrical data signal is carried by electrodes located above the optical waveguide. FIG. 1 is a schematic representation of a typical prior art Mach-Zehnder optical modulator 100.

For very wide bandwidth applications, conventional Mach-Zehnder optical modulators can achieve satisfactory modulation with long electrodes and high voltage electrical input signals. For example, for a modulator with a bandwidth of 0-40 GHz, the electrode length is expected to be approximately 50 millimeters and the signal voltage about 10 volts. However, there are practical limitations on achieving the high drive voltage and fabricating long electrodes. In this regard, increasing the electrode length corresponds to an increase in insertion loss and, consequently, an increase in the drive voltage requirement. A conventional electrode design utilized by traveling-wave optical modulators is configured as a coplanar waveguide transmission line (see FIGS. 1-3). This electrode design exhibits high conductor losses due to the small gaps between the drive signal electrode and the ground electrodes. In addition, velocity matching between the electrical signal and the optical wave can be difficult to achieve with this electrode design because the light travels effectively within the optical waveguides, whereas the electrical signal travels within the gaps with its field lines spreading into the air above the structure and into the underlying media. As a result, careful design of the electrodes is required in order to match the signal velocity to the light velocity.

### BRIEF SUMMARY OF THE INVENTION

An optical modulator using an electrode structure according to the present invention can offer very large bandwidth at high speeds and, if needed, can reduce the effects of optical fiber dispersion. The electrode structure can reduce the drive voltage requirements normally associated with conventional optical modulator designs by lowering the electrical insertion losses. The electrode structure provides designers with the freedom to achieve various design specifications, e.g., electrode transmission line impedance, losses, velocity matching, and the like.

The above and other aspects of the present invention may be carried out in one form by a traveling-wave optical modulator that includes a substrate having an upper surface, an optical waveguide located within the substrate, a ground electrode formed above the upper surface of the substrate, and a drive signal electrode comprising a coplanar section formed above the upper surface of the substrate and a fin section located above, and overlapping, the ground electrode.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic representation of a prior art Mach-Zehnder optical modulator;

FIG. 2 is a cross-sectional view of the optical modulator shown in FIG. 1, as viewed along line A-A;

FIG. 3 is a cross-sectional view of an alternate prior art Mach-Zehnder optical modulator;

FIG. 4 is a schematic representation of an optical modulator configured in accordance with the present invention;

FIG. 5 is a cross-sectional view of the optical modulator shown in FIG. 4, as viewed along line B-B;

FIG. 6 is a graph of electrode transmission line impedance versus fin width for a simulated optical modulator utilizing a finned electrode structure; and

FIG. 7 is a graph of RF index versus fin width for a simulated optical modulator utilizing a finned electrode structure.

### DETAILED DESCRIPTION OF A PREFERRED EMBODIMENT

The particular implementations shown and described herein are illustrative of the invention and its best mode and are not intended to otherwise limit the scope of the invention in any way. Indeed, for the sake of brevity, the operation of conventional optical modulators, conventional RF design techniques, and functional aspects of known components and subsystems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

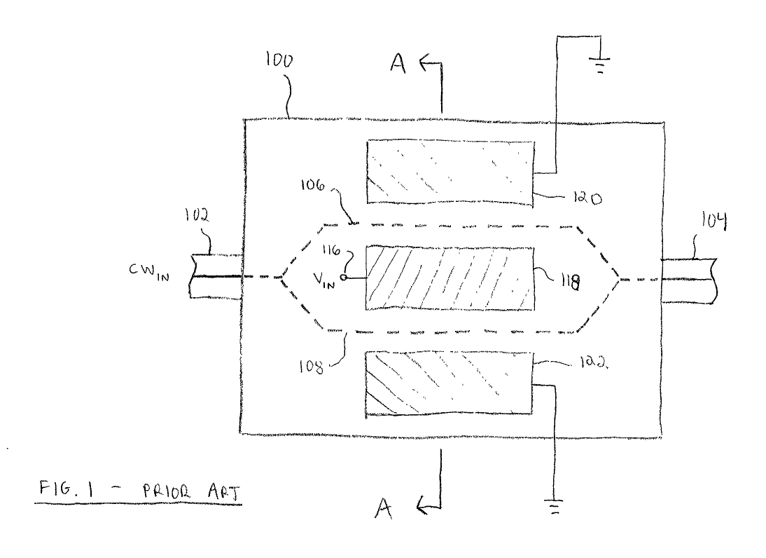

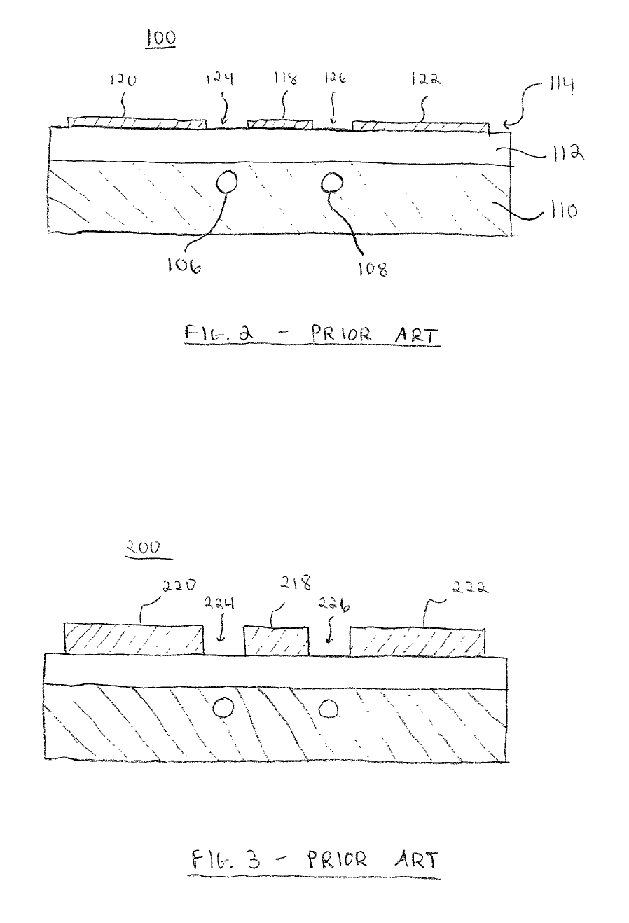

FIG. 1 is a schematic top view of a prior art Mach-Zehnder optical modulator 100, and FIG. 2 is a cross-sectional view of optical modulator 100 as viewed from line A-A (shown in FIG. 1). Optical modulator 100 receives a continuous wave (CW) optical input signal carried by an input optical fiber 102 and generates a modulated optical output signal carried by an output optical fiber 104. The optical signal travels in a branched optical waveguide arrangement having a first interferometric arm 106 and a second interferometric arm 108. The optical waveguide is formed within a substrate layer 110 of optical modulator 100. In a practical embodiment, the optical waveguide resides underneath both a dielectric layer 112 and a transmission line layer 114 of optical modulator 100 (for this reason, the optical waveguide, which would otherwise be hidden from view, is represented by dashed lines in FIG. 1).

A high frequency electrical data signal (e.g., an RF signal) is utilized to drive optical modulator 100. Optical modulator 100 receives the electrical drive signal via a suitable data input connection 116. The drive signal is carried by a suitable drive signal electrode 118. Optical modulator 100 also includes a first ground electrode 120 and a second ground electrode 122. Drive signal electrode 118, first ground electrode 120, and second ground electrode 122 (these electrodes can be located above the dielectric layer) combine to form a microwave transmission line, which is terminated by suitable resistances (not shown). This electrode structure is commonly referred to as a coplanar waveguide (CPW) transmission line. The electrical data signal modulates the optical signal in first interferometric arm 106 (due to the positioning of drive signal electrode 118 and first ground electrode 120 relative to first interferometric arm 106), and modulates the optical signal in second interferometric arm 108 (due to the positioning of drive signal electrode 118 and second ground electrode 122 relative to second interferometric arm 108).

The electrical data signal, which should travel along the electrodes at approximately the same speed as the light traveling in the optical waveguide, alters the refractive index of the optical waveguide. Due to the phase difference between the optical signal in the two interferometric arms, amplitude modulation occurs in the optical output signal. Since the change in the refractive index is small, either a high voltage electrical input signal or long electrodes is required in order to achieve satisfactory modulation. However, practical limitations on the drive voltage and the electrode length exist for very wide bandwidth, high frequency modulators.

The CPW transmission line includes a gap 124 between drive signal electrode 118 and first ground electrode 120, and a gap 126 between drive signal electrode 118 and second ground electrode 122. In most practical wide bandwidth, high frequency applications, gap 124 and gap 126 are each between 10 μm and 20 μm wide. These gaps contribute to electrical losses through the conductors. In addition, it may be difficult to achieve good velocity matching using conventional CPW transmission line designs. In response to these practical issues, a prior art CPW transmission line design utilizes thicker electrodes (see FIG. 3). FIG. 3 is a cross-section of a prior art optical modulator 200 having the same general characteristics as optical modulator 100. In this regard, optical modulator 200 includes a drive signal electrode 218, a first ground electrode 220, and a second ground electrode 222. As depicted in FIG. 3, the thickness of these electrodes is greater than the thickness of the electrodes utilized by optical modulator 100, which are typically less than 4 μm. For example, the thickness of the electrodes utilized by optical modulator 200 may be between 10 μm and 20 μm. The larger electrode thickness reduces the electrical losses and the air in gap 224 and gap 226 reduces the effective dielectric constant for the input data signal, thus facilitating a better velocity match. Fabrication of such thick electrodes with small gaps, however, is extremely difficult—the primary and challenging issues in the fabrication of such electrodes are avoiding “kissing” contacts and irregularities along the electrodes.

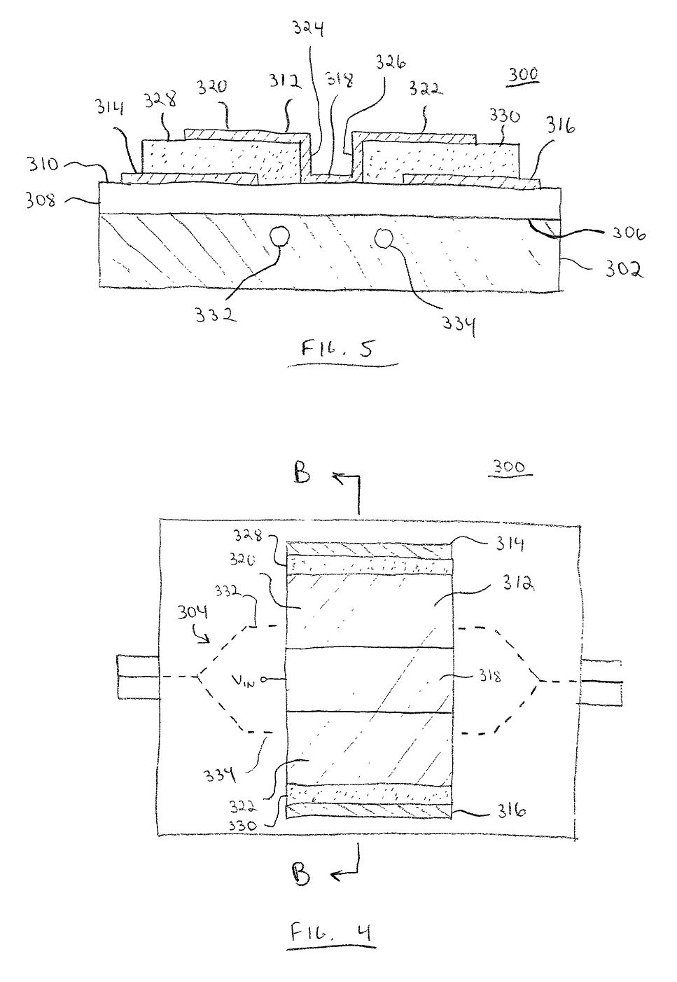

As an alternative to the above prior art optical modulators, a traveling-wave optical modulator configured in accordance with the present invention includes a low loss electrode structure that provides enhanced velocity matching while satisfying practical electrical impedance requirements. FIG. 4 is a schematic representation of a Mach-Zehnder optical modulator 300 configured in accordance with the present invention, and FIG. 5 is a cross-sectional view of optical modulator 300 as viewed along line B-B (shown in FIG. 4). Although FIG. 4 and FIG. 5 depict a basic electrode structure to simplify the description of optical modulator 300, the scope of the present invention is not limited to any specific electrode layout or design. Indeed, the electrode structure may follow a curved or bent path, the number and placement of the ground electrodes can vary, the optical modulator may include additional dielectric and/or electrode layers, the optical modulator need not utilize a Mach-Zehnder design, the thickness of the various layers (including the electrodes) may vary to suit the particular application, the cross-sectional configuration can differ from that shown in FIG. 5, and each of the various layers can be formed from any number of suitable materials.

Optical modulator 300 includes a substrate 302 and an optical waveguide 304 located within substrate 302. In the preferred embodiment, substrate 302 comprises lithium niobate (LiNbO₃) and optical waveguide 304 is formed within the lithium niobate in accordance with known techniques. Alternatively, substrate 302 can be formed from any dielectric, semi-insulating, and/or semi-conducting material (as a single layer or as a multiple-layer structure) having suitable electrical and optical characteristics. In this regard, substrate 302 may comprise gallium arsenide (GaAs) rather than lithium niobate. Substrate 302 has an upper surface 306 (see FIG. 5); other elements of optical modulator 300 are located above upper surface 306.

The illustrated example embodiment includes a dielectric layer 308 located above upper surface 306 of substrate 302. In practice, dielectric layer 308 is deposited on substrate 302 such that dielectric layer 308 contacts upper surface 306. Dielectric layer 308 has an upper surface 310; other elements of optical modulator 300 are located above upper surface 310. In accordance with one practical embodiment, dielectric layer 308 comprises silicon dioxide (SiO2). Dielectric layer 308 is primarily utilized to achieve velocity matching between the electrical signal carried by the electrodes (described below) and the optical signal carried by optical waveguide 304. Accordingly, dielectric layer 308 can be formed from any dielectric, semi-insulating, and/or semi-conducting material (as a single layer or as a multiple-layer structure) having suitable electrical characteristics. Furthermore, in some practical embodiments, optical modulator 300 need not employ dielectric layer 308 to obtain adequate velocity matching.

Optical modulator 300 includes electrodes that form an electrical transmission line. In this regard, optical modulator 300 includes a drive signal electrode 312 and at least one ground electrode. In the illustrated example embodiment, optical modulator 300 utilizes a first ground electrode 314 and a second ground electrode 316. In practice, drive signal electrode 312 and ground electrodes 314/316 are formed from an electrically conductive material such as a gold plated metal. Drive signal electrode 312, first ground electrode 314, and second ground electrode 316 are each located above upper surface 306 of substrate 302. In the illustrated embodiment, at least a portion of drive signal electrode 312, and each of the ground electrodes 314/316 are deposited on upper surface 310 of dielectric layer 308 such that the electrodes contact upper surface 310 and such that the electrodes are substantially coplanar on upper surface 310. In an alternate embodiment having no dielectric layer 308, the electrodes can be deposited on upper surface 306 of substrate 302.

For most practical embodiments, the thickness of the ground electrodes 314/316, and the thickness of the various portions of drive signal electrode 312, is typically between 1 μm to 4 μm. In the example embodiment, ground electrodes 314/316 and drive signal electrode 318 are configured such the gaps between the electrodes are spaced evenly throughout the electrode structure. The specific size and shape of ground electrodes 314/316 can vary according to the modulator and/or system specifications.

Drive signal electrode 312 generally includes a coplanar section 318, a first fin section 320, a second fin section 322, a first wall section 324 and a second wall section 326. Coplanar section 318 is located above upper surface 306 of substrate 302; in the example embodiment shown in FIG. 5, coplanar section 318 is formed on upper surface 310 of dielectric layer 308. The width of coplanar section 318 can vary depending upon the particular application of the electrode structure. In a practical embodiment, the thickness of coplanar section 318 is between 1 μm to 4 μm. Of course, the actual thickness of coplanar section 318 may vary to suit the particular application. The gap between coplanar section 318 and each of the ground electrodes 314/316 is approximately 10-20 μm.

First fin section 320 is located above first ground electrode 314, and second fin section 322 is located above second ground electrode 316. As best shown in FIG. 5, first fin section 320 overlaps at least a portion of first ground electrode 314, and second fin section 322 overlaps at least a portion of second ground electrode 316. First wall section 324 connects first fin section 320 to coplanar section 318, and second wall section 326 connects second fin section 322 to coplanar section 318. The thickness of fin sections 320/322, the thickness of wall sections 324/326, the height of wall sections 324/326, the width of fin sections 320/322, the width of ground electrodes 314/316, and the amount of overlap between fin sections 320/322 and the respective ground electrodes 314/316 can be selected to suit the needs of the particular application. In accordance with one example embodiment, the width of coplanar section 318, the width of the gaps between each of the ground electrodes 314/316 and coplanar section 318, and the height between each of the ground electrodes 314/316 and drive signal electrode 312 are all approximately 20 μm. In the example embodiment, the width of fin sections 320/322 is approximately 60 μm, and the width of the ground electrodes 314/316 is at least twice the width of fin sections 320/322.

Optical modulator preferably includes an electrode dielectric layer having a first portion 328 located between first ground electrode 314 and first fin section 320, and a second portion 330 located between second ground electrode 316 and second fin section 322. In accordance with one practical embodiment, this electrode dielectric layer comprises a polyimide material. First electrode dielectric portion 328 and second electrode dielectric portion 330 are primarily utilized to achieve velocity matching between the electrical signal carried by the electrodes and the optical signal carried by optical waveguide 304. Accordingly, first and second electrode dielectric portions 328/330 may be formed from any dielectric, semi-insulating, and/or semi-conducting material (as a single layer or as a multiple-layer structure) having suitable electrical characteristics. In accordance with a practical embodiment, dielectric layer 308 and the electrode dielectric layer including first and second portions 328/330 have different electrical characteristics, e.g., different dielectric constants.

In preferred embodiments, the width of first electrode dielectric portion 328 exceeds the width of first fin section 320, and the width of second electrode dielectric portion 330 exceeds the width of second fin section 322. In other words, the electrode dielectric material preferably extends beyond the edges of the fin sections. In a practical embodiment, the electrode dielectric material under the fin sections need not extend to the outer edges of the respective ground electrodes. As shown in FIG. 5, first and second electrode dielectric portions 328/330 are formed such that they fill the space between fin sections 320/322 and dielectric layer 308, and the space between fin sections 320/322 and ground electrodes 314/316. The cross-sectional configuration of drive signal electrode 312 (as shown in FIG. 5) can vary depending upon the practical application of the electrode structure.

An electrode structure according to the present invention functions as both a CPW structure and a microstrip structure. In this regard, coplanar section 318 of drive signal electrode 312 and ground electrodes 314/316 are configured to support a CPW signal transmission mode, while fin sections 320/322 of drive signal electrode 312 and respective ground electrodes 314/316 are configured to support a microstrip signal transmission mode. In the CPW signal transmission mode, electromagnetic energy passes between coplanar section 318 and ground electrodes 314/316 via dielectric layer 308 and/or substrate 302. In the microstrip signal transmission mode, electromagnetic energy passes between fin sections 320/322 and respective ground electrodes 314/316 via the respective electrode dielectric portions 328/330. Other than this dual mode feature, optical modulator 300 shown in FIG. 4 and FIG. 5 generally operates in the manner described above in connection with optical modulator 100. In this regard, optical waveguide 304 includes a first interferometric arm 332 and a second interferometric arm 334, each located within substrate 302. The drive signal carried by drive signal electrode 312 modulates the optical signal in first and second interferometric arms 332/334.

Relative to a conventional CPW electrode design, the effective width of drive signal electrode 318 is significantly greater than the width of a conventional drive signal electrode. With reference to FIG. 5, the width of coplanar section 318 of drive signal electrode 312 can be compared to the width of a conventional CPW drive signal electrode. In contrast, the effective width of drive signal electrode 318 is equal to the width of coplanar section 318 plus the width of the fin sections 320/322. Considering a conventional CPW transmission line impedance as the reference impedance, the fin sections 320/322 reduce the impedance and reduce the velocity of the electromagnetic energy carried by the electrode structure. Furthermore, due to the large effective width of drive signal electrode 318, the electrode insertion losses are lower than that of a conventional CPW transmission line structure. These results occur because the fin sections 320/322 deliver a large portion of the electromagnetic energy between the drive signal electrode 318 and the ground electrodes 314/316.

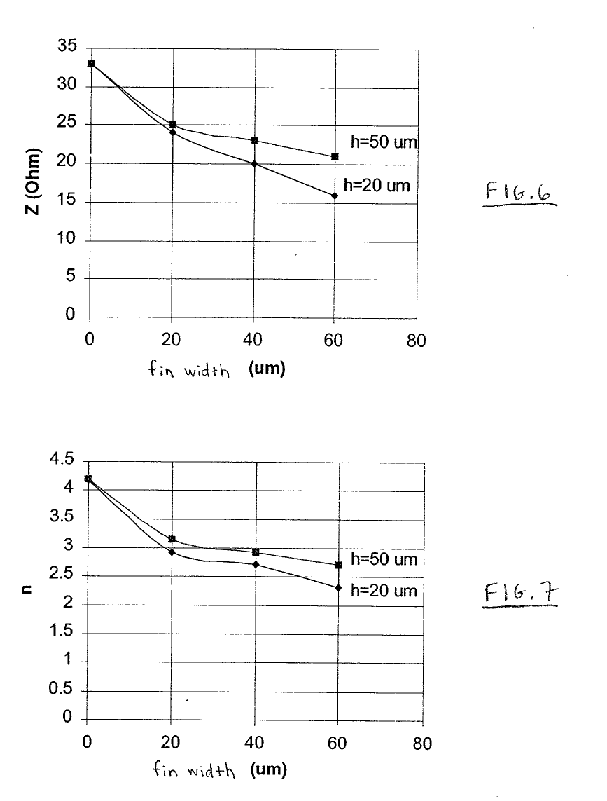

FIG. 6 is a graph of electrode transmission line impedance versus fin width for a simulated optical modulator utilizing a finned electrode structure as described above. FIG. 7 is a graph of RF index versus fin width for a simulated optical modulator utilizing a finned electrode structure as described above. In these figures, h represents the thickness of the dielectric layer between the ground and fin electrodes. The simulations were performed using the ADS simulation software from Agilent Corporation. For purposes of the simulations, the gap between each of the ground electrodes and the coplanar section of the drive signal electrode is 20 μm, the width of the coplanar section of the drive signal electrode is 20 μm, the width of the electrode dielectric portions between the fin sections and the ground sections is infinite (for ease of simulation), and the optical modulator includes no dielectric layer between the substrate and the electrodes. In FIG. 6 and FIG. 7, a fin width of zero represents a CPW electrode structure having a polyimide dielectric layer covering the signal and ground electrodes.

As the fin width increases, the characteristic impedance of the electrical transmission line decreases (see FIG. 6). As the fin width increases, the RF index of the electrical transmission line decreases (see FIG. 7). Thus, the electrical wave velocity increases as the fin widths increase, which enables velocity matching through adjustment of the fin width (ideally, the RF index should match the refractive index of the optical waveguide). In a practical embodiment, the refractive index of a lithium niobate optical waveguide is 2.15. As shown in FIG. 7, the RF index approaches 2.15 as the fin width increases. FIG. 6 and FIG. 7 depict simulation results for optical modulators where the electrode dielectric layer between the fin sections and the ground electrodes is 20 μm and 50 μm. As the thickness of the dielectric layer increases, the effects of the increased fin width become attenuated.

As mentioned above, the simulated results assume that the width of the electrode dielectric portions is infinite. However, in a practical embodiment, the width of the electrode dielectric material between the fin sections and the ground electrodes can be varied in order to control the characteristic impedance and the phase velocity of the electrical signal carried by the electrodes. When the width of the electrode dielectric is approximately equal to the width of the respective fin sections, some of the fringing field lines of the capacitor will pass through air rather than the electrode dielectric. The amount of fringing fields in the air can be altered by modifying the width of the electrode dielectric, thus altering the capacitance of the electrode structure and the resulting phase velocity. Consequently, the electrode structure of the present invention provides designers with more degrees of freedom in order to achieve design specifications, e.g., impedance matching, conductor losses, and the like.

An electrode structure according to the present invention need not be utilized in the context of an optical modulator. The a finned drive signal electrode design may be suitably implemented in other RF and/or microwave applications. For example, the electrode structure described herein may be employed in monolithic microwave integrated circuits (MMICs) and opto-electronic integrated circuits (OEICs).

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A traveling-wave optical modulator comprising:
a substrate having an upper surface;
an optical waveguide located within said substrate;
a ground electrode located above said upper surface of said substrate; and
a drive signal electrode comprising a coplanar section located above said upper surface of said substrate and a fin section located above, and overlapping, said ground electrode.

2. A traveling-wave optical modulator according to claim 1, further comprising a dielectric layer formed on said upper surface of said substrate, said dielectric layer having an upper surface, wherein said ground electrode and said coplanar section of said drive signal electrode are each formed on said upper surface of said dielectric layer.

3. A traveling-wave optical modulator according to claim 1, further comprising a dielectric layer located between said ground electrode and said fin section of said drive signal electrode.

4. A traveling-wave optical modulator according to claim 3, further comprising a second dielectric layer formed on said upper surface of said substrate, said second dielectric layer having an upper surface, wherein said ground electrode and said coplanar section of said drive signal electrode are each formed on said upper surface of said second dielectric layer.

5. A traveling-wave optical modulator according to claim 4, wherein said dielectric layer and said second dielectric layer have different electrical characteristics.

6. A traveling-wave optical modulator according to claim 4, wherein:
said substrate comprises lithium niobate (LiNbO₃);
said dielectric layer comprises a polyimide material; and
said second dielectric layer comprises silicon dioxide (SiO₂).

7. A traveling-wave optical modulator according to claim 3, wherein the width of said dielectric layer exceeds the width of said fin section of said drive signal electrode.

8. A traveling-wave optical modulator according to claim 1, wherein said drive signal electrode further comprises a wall section connecting said coplanar section of said drive signal electrode to said fin section of said drive signal electrode.

9. A traveling-wave optical modulator according to claim 1, wherein:
said coplanar section of said drive signal electrode and said ground electrode are configured to support a coplanar waveguide signal transmission mode; and
said fin section of said drive signal electrode and said ground electrode are configured to support a microstrip signal transmission mode.

10. An optical modulator electrode structure comprising:
a planar ground electrode;
a drive signal electrode comprising a first section proximate said ground electrode, and a second section located above, and overlapping, said ground electrode; and
a dielectric layer located between said ground electrode and said second section of said drive signal electrode.

11. An electrode structure according to claim 10, wherein said dielectric layer comprises a semiconductor material.

12. An electrode structure according to claim 10, wherein said dielectric layer comprises a polyimide material.

13. An electrode structure according to claim 10, wherein the width of said dielectric layer exceeds the width of said second section of said drive signal electrode.

14. An electrode structure according to claim 10, wherein said drive signal electrode further comprises a third section connecting said first section of said drive signal electrode to said second section of said drive signal electrode.

15. An electrode structure according to claim 10, wherein:
said first section of said drive signal electrode and said ground electrode are configured to support a coplanar waveguide signal transmission mode; and
said second section of said drive signal electrode and said ground electrode are configured to support a microstrip signal transmission mode.

16. An optical modulator electrode structure comprising:
a first ground electrode;
a second ground electrode that is coplanar with said first ground electrode;
a drive signal electrode comprising a coplanar section that is coplanar with said first and second ground electrodes, a first fin section located above, and overlapping, said first ground electrode, and a second fin section located above, and overlapping, said second ground electrode; and
a dielectric layer comprising a first portion located between said first ground electrode and said first fin section of said drive signal electrode, and a second portion located between said second ground electrode and said second fin section of said drive signal electrode.

17. An electrode structure according to claim 16, wherein said dielectric layer comprises a semiconductor material.

18. An electrode structure according to claim 16, wherein:
the width of said first portion of said dielectric layer exceeds the width of said first fin section of said drive signal electrode; and
the width of said second portion of said dielectric layer exceeds the width of said second fin section of said drive signal electrode.

19. An electrode structure according to claim 16, wherein said drive signal electrode further comprises:
a first wall section connecting said coplanar section of said drive signal electrode to said first fin section of said drive signal electrode; and
a second wall section connecting said coplanar section of said drive signal electrode to said second fin section of said drive signal electrode.
